(19) United States
(12) Patent Application Publication
(10) Pub. No.: US 2011/0317397 A1
(43) Pub. Date: Dec. 29, 2011

(54) Quantum dot wavelength conversion for hermetically sealed optical devices

(75) Inventors: Troy Anthony Trottier, Fremont, CA (US); Michael Ragan Krames, Los Altos, CA (US); Rajat Sharma, Fremont, CA (US); Frank Tin Chung Shum, Sunnyvale, CA (US)

(73) Assignee: Soraa, Inc., Fremont, CA (US)

(21) Appl. No.: 13/135,087

(22) Filed: Jun. 23, 2011

Related U.S. Application Data
(63) Continuation-in-part of application No. 13/014,622, filed on Jan. 26, 2011.
(60) Provisional application No. 61/374,371, filed on Aug. 17, 2010.
(60) Provisional application No. 61/357,849, filed on Jun. 23, 2010.

(51) Int. Cl. F21V 9/16; H01J 9/26

(52) U.S. Cl. 362/84; 445/44

(57) ABSTRACT

An LED based lighting source is disclosed in which color correcting quantum dots convert emitted blue light to white light.

### CROSS-REFERENCE TO RELATED APPLICATIONS

This application claims priority to U.S. Provisional Patent Application No. 61/374,371, filed Aug. 17, 2010, and is a continuation-in-part application to U.S. patent application Ser. No. 13/014,622, filed Jan. 26, 2011, which claims priority to U.S. Provisional Patent Application No. 61/357,849, filed Jun. 23, 2010, all of which are incorporated by reference herein for all purposes.

### BACKGROUND OF THE INVENTION

The present invention relates generally to lighting and embodiments of the invention include techniques for transmitting electromagnetic radiation from LED devices, such as ultra-violet, violet, blue, blue and yellow, or blue and green, fabricated on bulk semi-polar, polar or nonpolar materials with use of phosphors, which emit light in a reflection mode. The invention can be applied to white lighting, multi-colored lighting, general illumination, decorative lighting, automotive and aircraft lamps, street lights, lighting for plant growth, indicator lights, lighting for flat panel displays, other optoelectronic devices, and the like.

In the late 1800's, Thomas Edison invented the light bulb. The conventional light bulb, commonly called the “Edison bulb,” has been used for over one hundred years and uses a tungsten filament enclosed in a glass bulb sealed in a base, which is screwed into a socket. The socket is coupled to an AC power or DC power source. Unfortunately, the conventional light bulb dissipates more than 90% of the energy used as thermal energy. Additionally, the light bulb routinely fails often due to thermal expansion and contraction of the filament element.

Solid state lighting techniques are known. Solid state lighting relies upon semiconductor materials to produce light emitting diodes, commonly called LEDs. Red LEDs use Aluminum Indium Gallium Phosphide (AlInGaP) semiconductor materials. Recently, Shuji Nakamura pioneered the use of InGaN materials to produce LEDs emitting blue light. Other colored LEDs have also been proposed.

High intensity UV, blue, and green LEDs based on GaN have been demonstrated. Efficiencies have typically been highest in the UV-violet, dropping off as the emission wavelength increases to blue or green. Unfortunately, achieving high intensity, high-efficiency GaN-based green LEDs has been problematic. The performance of optoelectronic devices fabricated on conventional c-plane GaN suffer from strong internal polarization fields, which spatially separate the electron and hole wave functions and lead to poor radiative recombination efficiency. Since this phenomenon becomes more pronounced in InGaN layers with increased indium content for increased wavelength emission, extending the performance of UV or blue GaN-based LEDs to the blue-green or green regime has been difficult. Furthermore, since increased indium content films often require reduced growth temperature, the crystal quality of the InGaN films is degraded. The difficulty of achieving a high intensity green LED has lead scientists and engineers to the term “green gap” to describe the unavailability of such green LEDs. In addition, the light emission efficiency of typical GaN-based LEDs drops off significantly at higher current densities, as are required for general illumination applications, a phenomenon known as “roll-over.” Other limitations with blue LEDs using c-plane GaN exist. These limitations include poor yields, low efficiencies, and reliability issues. Although highly successful, solid state lighting techniques must be improved for full exploitation of their potential.

### BRIEF SUMMARY OF THE INVENTION

This invention provides an optical device with a substrate having a surface region. The substrate is preferably metal, for example, Alloy 42 or copper, however, dielectrics, plastics, or other materials have also been used. The substrate is preferably a lead frame with LED devices placed on it. The device also includes wavelength conversion material disposed on the surface. A wavelength selective surface substantially blocks direct emission of the LED devices and transmits selected wavelengths of reflected emission caused by an interaction with the wavelength conversion material. In a preferred embodiment, the wavelength selective surface is a transparent material with filtering properties. In a preferred embodiment, the wavelength selective surface is a transparent material such as distributed Bragg Reflector (DBR) stack, a diffraction grating, a particle layer tuned to scatter selective wavelengths, a photonic crystal structure, a nanoparticle layer tuned for plasmon resonance enhancement at certain wavelengths, or a dichroic filter.

In an alternative embodiment, the present invention provides a method for emitting electromagnetic radiation of a desired wavelength. The method comprises subjecting wavelength conversion materials with electromagnetic radiation derived from optoelectronic devices. The electromagnetic radiation is substantially within a first wavelength range, and causes emission of electromagnetic radiation at a second wavelength range from an interaction of the electromagnetic radiation with the wavelength conversion material, preferably emitting radiation which is 90 degrees from the second direction.

In still a further embodiment, the invention provides a substrate with a surface region having LEDs and wavelength conversion material is disposed on the substrate, however, lower than the surface of the LEDs. preferably the wavelength conversion material is within about three hundred microns of a thermal sink having a thermal conductivity of between about 15 Watt/m-Kelvin and 300 Watt/m-Kelvin. In a specific embodiment, the wavelength conversion material is characterized by an average particle-to-particle distance between less than about 2 times the average particle size to about 5 times the particle size. In another embodiment, the wavelength conversion material is a filter with a wavelength selective surface such as distributed Bragg Reflector (DBR) stack, a diffraction grating, a particle layer tuned to scatter selective wavelengths, a photonic crystal structure, a nanoparticle layer tuned for plasmon resonance enhancement at certain wavelengths, or a dichroic filter.

The present device and method provides for an improved lighting technique with improved efficiencies which can be implemented using conventional technologies. In a specific embodiment, a blue LED device is capable of emitting electromagnetic radiation at a wavelength range from about 450 nanometers to about 495 nanometers and the yellow-green LED device is capable of emitting electromagnetic radiation at a wavelength range from about 495 nanometers to about 590 nanometers.

### BRIEF DESCRIPTION OF THE DRAWINGS

FIG. 1 is a diagram of packaged light emitting devices using a carrier;

FIG. 1A is an example of an electron/hole wave functions;

FIGS. 2 through 12 are diagrams of alternative packaged light emitting devices using reflection mode configurations;

FIG. 13 is a diagram illustrating an LED apparatus having quantum dots;

FIG. 14 is a diagram illustrating a hermetically sealed LED package; and

FIGS. 15A-15C are diagrams illustrating LED packages with a canopy shaped lid.

### DETAILED DESCRIPTION OF THE INVENTION

Recent breakthroughs in GaN-based optoelectronics have demonstrated the potential of devices fabricated on bulk non-polar and semi-polar GaN substrates. The lack of strong polarization induced electric fields that plague conventional devices on c-plane GaN leads to a enhanced radiative recombination efficiency in the light emitting InGaN layers. Furthermore, the nature of the electronic band structure and the anisotropic in-plane strain leads to highly polarized light emission which offers advantages in applications such as display backlighting.

Light emitting diodes fabricated on nonpolar and semipolar GaN substrates have exhibited record output powers at extended operation wavelengths into the violet region (390-430 nm), the blue region (430-490 nm), the green region (490-560 nm), and the yellow region (560-600 nm). For example, a violet LED, with a peak emission wavelength of 402 nm, was recently fabricated on an m-plane (1-100) GaN substrate and demonstrated greater than 45% external quantum efficiency, despite having no light extraction enhancement features, and showed excellent performance at high current densities, with minimal roll-over [K.-C. Kim, M. C. Schmidt, H. Sato, F. Wu, N. Fellows, M. Saito, K. Fujito, J. S. Speck, S, Nakamura, and S. P. DenBaars, “Improved electroluminescence on nonpolar m-plane InGaN/GaN quantum well LEDs”, Phys. Stat. Sol. (RRL) 1, No. 3, 125 (2007).]. Similarly, a blue LED, with a peak emission wavelength of 468 nm, exhibited excellent efficiency at high power densities and significantly less roll-over than is typically observed with c-plane LEDs [K. Iso, H. Yamada, H. Hirasawa, N. Fellows, M. Saito, K. Fujito, S. P. DenBaars, J. S. Speck, and S, Nakamura, “High brightness blue InGaN/GaN light emitting diode on nonpolar m-plane bulk GaN substrate”, Japanese Journal of Applied Physics 46, L960 (2007).]. Two promising semipolar orientations are the (10-1-1) and (11-22) planes. These planes are inclined by 62.0 degrees and by 58.4 degrees, respectively, with respect to the c-plane.

University of California, Santa Barbara (UCSB) has produced highly efficient LEDs on (10-1-1) GaN with over 65 mW output power at 100 mA for blue-emitting devices [H. Zhong, A. Tyagi, N. Fellows, F. Wu, R. B. Chung, M. Saito, K. Fujito, J. S. Speck, S. P. DenBaars, and S, Nakamura, “High power and high efficiency blue light emitting diode on freestanding semipolar(1011) bulk GaN substrate”, Applied Physics Letters 90, 233504 (2007)] and on (11-22) GaN with over 35 mW output power at 100 mA for blue-green emitting devices [H. Zhong, A. Tyagi, N. N. Fellows, R. B. Chung, M. Saito, K. Fujito, J. S. Speck, S. P. DenBaars, and S, Nakamura, Electronics Lett. 43, 825 (2007)], over 15 mW of power at 100 mA for green-emitting devices [H. Sato, A. Tyagi, H. Zhong, N. Fellows, R. B. Chung, M. Saito, K. Fujito, J. S. Speck, S. P. DenBaars, and S, Nakamura, “High power and high efficiency green light emitting diode on free-standing semipolar (1122) bulk GaN substrate”, Physical Status Solidi—Rapid Research Letters 1, 162 (2007)] and over 15 mW for yellow devices [H. Sato, R. B. Chung, H. Hirasawa, N. Fellows, H. Masui, F. Wu, M. Saito, K. Fujito, J. S. Speck, S. P. DenBaars, and S. Nakamura, “Optical properties of yellow light-emitting diodes grown on semipolar (1122) bulk GaN substrates,” Applied Physics Letters 92, 221110 (2008).]. The UCSB group has shown that the indium incorporation on semipolar (11-22) GaN is comparable to or greater than that of c-plane GaN, which provides further promise for achieving high crystal quality extended wavelength emitting InGaN layers.

With high-performance single-color non-polar and semi-polar LEDs, several types of white light sources are now possible. In one embodiment, a violet non-polar or semi-polar LED is packaged with a blend of three phosphors, emitting in the blue, the green, and the red. In another embodiment, a blue non-polar or semi-polar LED is packaged with a blend of two phosphors, emitting in the green and the red. In still another embodiment, a green or yellow non-polar or semi-polar LED is packaged with a blue non-polar or semi-polar LED and at least one phosphor which emits in the red.

A non-polar or semi-polar LED may be fabricated on a bulk gallium nitride substrate. The gallium nitride substrate can be sliced from a boule that was grown by hydride vapor phase epitaxy or ammonothermally, according to methods known in the art. In one specific embodiment, the gallium nitride substrate is fabricated by a combination of hydride vapor phase epitaxy and ammonothermal growth, as disclosed in U.S. Patent Application No. 61/078,704, commonly assigned, and hereby incorporated by reference. The boule may be grown in the c-direction, the m-direction, the a-direction, or in a semi-polar direction on a single-crystal seed crystal. Semipolar planes may be designated by (hkil) Miller indices, where i=−(h+k), l is nonzero and at least one of h and k are nonzero. The gallium nitride substrate may be cut, lapped, polished, and chemical-mechanically polished. The gallium nitride substrate orientation may be within ±5 degrees to ±0.5 degrees of the {1-1 0 0} m plane, the {1 1-2 0} a plane, the {1 1-2 2} plane, the {2 0-2 ±1} plane, the {1-1 0 ±1} plane, the {1-1 0-±2} plane, or the {1-1 0 ±3} plane. The gallium nitride substrate has a dislocation density in the plane of the large-area surface that is between 10⁶ cm⁻² and 10³ cm⁻². The gallium nitride substrate preferably has a dislocation density in the c plane that is between 10⁶ cm⁻² and 10³ cm⁻².

A homoepitaxial non-polar or semi-polar LED is fabricated on the gallium nitride substrate according to methods that are known in the art, for example, following the methods disclosed in U.S. Pat. No. 7,053,413, which is hereby incorporated by reference in its entirety. At least one AlₓIn_{y}Ga_{1-x-y}N layer, where 0≦x≦1, 0≦y≦1, and 0≦x+y≦1, is deposited on the substrate, for example, following the methods disclosed by U.S. Pat. Nos. 7,338,828 and 7,220,324, also hereby incorporated by reference in their entirety. The at least one AlₓIn_{y}Ga_{1-x-y}N layer may be deposited by metal-organic chemical vapor deposition, by molecular beam epitaxy, by hydride vapor phase epitaxy, or by a combination thereof. The AlₓIn_{y}Ga_{1-x-y}N layer comprises an active layer that preferentially emits light when an electrical current is passed through it. The active layer can be a single quantum well, with a thickness between about 0.5 nm and about 40 nm. In a specific embodiment, the active layer comprises a single quantum well with a thickness between about 1 nm and about 5 nm. In other embodiments, the active layer comprises a single quantum well with a thickness between about 5 nm and about 40 nm. In another embodiment, the active layer is a multiple quantum well. In still another embodiment, the active region comprises a double heterostructure, with a thickness between about 40 nm and about 500 nm. In one specific embodiment, the active layer comprises an In_{y}Ga_{1-y}N layer, where 0≦y≦1.

In a specific embodiment, the present invention provides novel packages and devices including at least one non-polar or at least one semi-polar homoepitaxial LED is placed on a substrate. In other embodiments, the starting materials can include polar gallium nitride containing materials. The present packages and devices can be combined with phosphors to discharge white light.

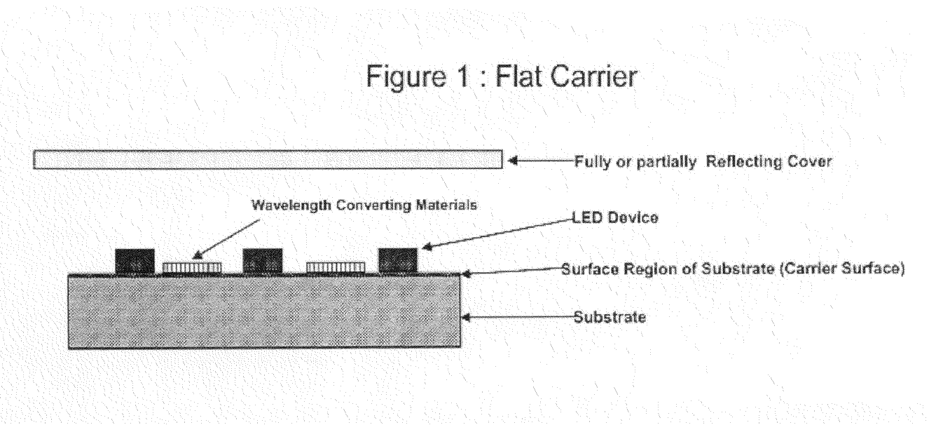

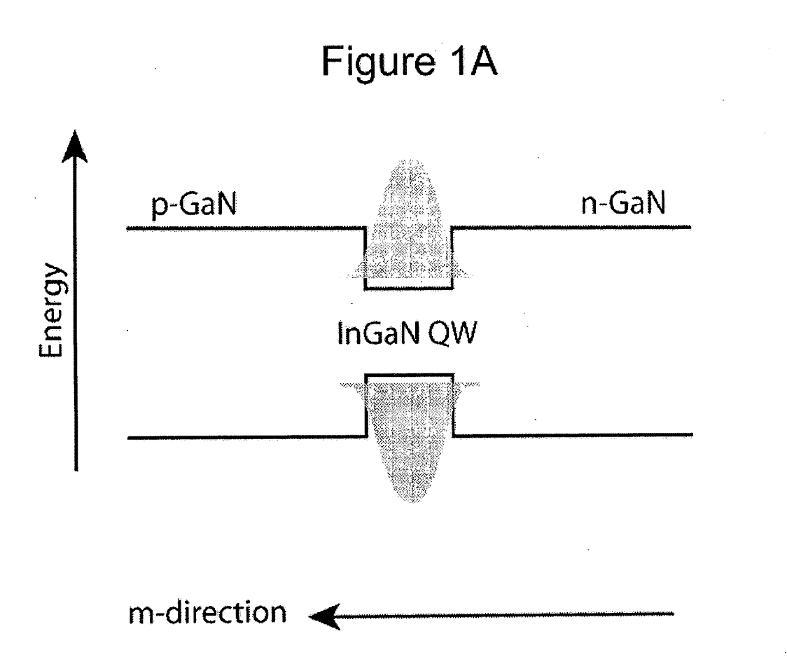

FIG. 1 is a diagram of a flat carrier packaged light emitting device 100. As shown, the device has a substrate member which has a surface. The substrate is made of a suitable material such as alloy 42, copper, plastic, dielectric, or other materials. Preferably the substrate is a lead frame member.

The surface region of the flat carrier is substantially flat, although it may also be cupped or terraced, or a combination of flat and cupped shapes. Additionally, the surface region generally has a smooth surface formed by plating, or coating with gold, silver, platinum, aluminum, or other material suitable for bonding to an overlying semiconductor material.

Referring again to FIG. 1, the device has light emitting diode devices overlying the surface region. The light emitting diode devices 103 are fabricated on a semipolar or nonpolar GaN containing substrate, but can also be on polar gallium and nitrogen containing material. The LEDs emit polarized electromagnetic radiation. The LEDs are coupled to a potential source.

In a specific embodiment, the device has at least one of the light emitting diode devices provided as a quantum well region characterized by an electron wave function and a hole wave function. The electron wave function and the hole wave function are substantially overlapped within a predetermined spatial region. An example of the electron wave function and the hole wave function is provided by FIG. 1A.

In a preferred embodiment, the light emitting diode is a blue LED emitting electromagnetic radiation at a range from about 430 nanometers to about 490 nanometers. A {1-1 0 0} m-plane bulk substrate or a {1 0-1-1} semi-polar bulk substrate is provided for the semipolar blue LED. The substrate has a flat surface, with a root-mean-square (RMS) roughness of about 0.1 nm, a threading dislocation density less than 5×10⁶ cm⁻², and a carrier concentration of about 1×10¹⁷ cm⁻³. Epitaxial layers are deposited on the substrate by metalorganic chemical vapor deposition (MOCVD) at atmospheric pressure. The ratio of the flow rate of the group V precursor (ammonia) to that of the group III precursor (trimethyl gallium, trimethyl indium, trimethyl aluminum) during growth is between about 3000 and about 12000. First, a contact layer of n-type (silicon-doped) GaN is deposited on the substrate, with a thickness of about 5 microns and a doping level of about 2×10¹⁸ cm⁻³. Next, an undoped InGaN/GaN multiple quantum well (MQW) is deposited as the active layer. The MQW superlattice has six periods, comprising alternating layers of 8 nm of InGaN and 37.5 nm of GaN as the barrier layers. Next, a 10 nm undoped AlGaN electron blocking layer is deposited. Finally, a p-type GaN contact layer is deposited, with a thickness of about 200 nm and a hole concentration of about 7×10¹⁷ cm⁻³. Indium tin oxide (ITO) is e-beam evaporated onto the p-type contact layer as the p-type contact and rapid-thermal-annealed. LED mesas, with a size of about 300×300 μm², are formed by photolithography and dry etching using a chlorine-based inductively-coupled plasma (ICP) technique. Ti/Al/Ni/Au is e-beam evaporated onto the exposed n-GaN layer to form the n-type contact, Ti/Au is e-beam evaporated onto a portion of the ITO layer to form a p-contact pad, and the wafer is diced into discrete LED dies. Electrical contacts are formed by conventional wire bonding.

The flat carrier has a thickness of wavelength conversion materials separate from the LEDs. The wavelength conversion materials convert electromagnetic radiation reflected off the wavelength selective material, as shown. The wavelength conversion materials are excited by the substantially polarized emission and emit electromagnetic radiation of second wavelengths, e.g. yellow light from an interaction with the polarized blue light. In a specific embodiment, the thickness of the phosphors providing wavelength conversion is less than about five microns.

In a specific embodiment, the phosphor or phosphor blend is selected from one or more of (Y, Gd, Tb, Sc, Lu, La)₃(Al, Ga, In)₅O₁₂:Ce³⁺, SrGa₂S₄:Eu²⁺, SrS:Eu²⁺, and colloidal quantum dot thin films comprising CdTe, ZnS, ZnSe, ZnTe, CdSe, or CdTe. In other embodiments, the device may include a phosphor capable of emitting substantially red light. Such phosphor is selected from one or more of (Gd,Y,Lu,La)₂O₃:Eu³⁺, Bi³⁺; (Gd,Y,Lu,La)₂O₂S:Eu³⁺, Bi³⁺; (Gd,Y,Lu,La)VO₄:Eu³⁺, Bi³⁺; Y₂(O,S)₃:Eu³⁺; Ca₁₋ₓMo_{1-y}Si_{y}O₄: where 0.05≦x≦0.5, 0≦y≦0.1; (Li,Na,K)₅Eu(W,Mo)O₄; (Ca,Sr)S:Eu²⁺; SrY₂S₄:Eu²⁺; CaLa₂S₄:Ce³⁺; (Ca,Sr)S:Eu²⁺; 3.5MgO*0.5MgF₂*GeO₂:Mn⁴⁺ (MFG); (Ba,Sr,Ca)MgxP₂O₇:Eu²⁺, Mn²⁺; (Y,Lu)₂WO₆:Eu³⁺, Mo⁶⁺; (Ba,Sr,Ca)₃MgxSi₂O₈:Eu²⁺, Mn²⁺, wherein 1≦x≦2; (RE_{1-y}Ce_{y})Mg₂₋ₓLiₓSi₃₋ₓPₓO₁₂, where RE is at least one of Sc, Lu, Gd, Y, and Tb, 0.0001<x<0.1 and 0.001≦y≦0.1; (Y, Gd, Lu, La)₂₋ₓEuₓW_{1-y}Mo_{y}O₆, where 0.5≦x.≦1.0, 0.01≦y≦1.0; (SrCa)₁₋ₓEuₓSi₅N₈, where 0.01≦x≦0.3; SrZnO₂:Sm⁺³; MₘOₙX wherein M is selected from the group of Sc, Y, a lanthanide, an alkali earth metal and mixtures thereof; X is a halogen; 1≦m≦3; and 1≦n≦4, and wherein the lanthanide doping level can range from 0.1 to 40% spectral weight; and Eu³⁺ activated phosphate or borate phosphors; and mixtures thereof.

The wavelength conversion materials can be ceramic, thin-film-deposited, or discrete particle phosphors, ceramic or single-crystal semiconductor plate down-conversion materials, organic or inorganic down converters, nanoparticles, or other materials which absorb photons of a primary energy and emit photons of a secondary energy (“wavelength conversion”). As an example, the wavelength conversion materials include, but are not limited to the following:

(Sr,Ca)₁₀(PO₄)₆*DB₂O₃:Eu²⁺ (wherein 0<n₁)

### (Ba,Sr,Ca)₅(PO₄)₃(Cl,F,Br,OH):Eu²⁺,Mn²⁺

### (Ba,Sr,Ca)BPO₅:Eu²⁺,Mn²⁺

### Sr₂Si₃O₈*2SrC₁₂:Eu²⁺

### (Ca,Sr,Ba)₃MgSi₂O₈:Eu²⁺, Mn²⁺

### BaA₁₈O₁₃:Eu²⁺

### ₂SrO*0.84P₂O₅*0.16B₂O₃:Eu²⁺

### (Ba,Sr,Ca)MgAl₁0O₁₇:Eu²⁺,Mn²⁺

### (Ba,Sr,Ca)Al₂O₄:Eu²⁺

### (Y,Gd,Lu,Sc,La)BO₃:Ce³⁺,Tb³⁺

### (Ba,Sr,Ca)₂(Mg,Zn)Si₂O₇:Eu²⁺

(Mg,Ca,Sr, Ba,Zn)₂Si₁_{_{—}}ₓO₄_{_{—2}}x:Eu²⁺ (wherein 0<x=0.2)

### (Sr,Ca,Ba)(Al,Ga,m)₂S₄:Eu²⁺

(Lu,Sc,Y,Tb)₂_{_{—}}ᵤ_{_{—}}ᵥCevCa₁₊ᵤLiwMg₂_{_{—}}_{w}Pw(Si,Ge)₃_{_{—}}_{w}01₂_{_{—}}ᵤ/2 where —O.SSû1; 0<v£Q.1; and OSŵO.2

### (Ca,Sr)₈(Mg,Zn)(SiO₄)₄C₁₂:Eu²⁺,Mn²⁺

### Na₂Gd₂B₂O₇:Ce³⁺,Tb³⁺

### (Sr,Ca,Ba,Mg,Zn)₂P₂O₇:Eu²⁺,Mn²⁺

### (Gd,Y,Lu,La)₂O₃:Eu³⁺,Bi³⁺

### (Gd,Y,Lu,La)₂O₂S:Eu³⁺,Bi³⁺

### (Gd,Y,Lu,La)ᵥO₄:Eu³⁺,Bi³÷

### (Ca,Sr)S:Eu²⁺,Ce³⁺

(Y,Gd,Tb,La,Sm,Pr,Lu)₃(Sc,Al,Ga)₅_{_{—}}ₙO₁₂_{_{—}}₃/₂n:Ce³⁺ (wherein 0̂0̂0.5)

### ZnS:Cu⁺,Cl˜

### ZnS:Cu⁺,Al³⁺

### ZnS:Ag⁺,Al³⁺

### SrY₂S₄:Eu²⁺

### CaLa₂S₄:Ce³⁺

### (Ba,Sr,Ca)MgP₂O₇:Eu2+,Mn²⁺

### (Y,Lu)₂WO₆:Eu³⁺,Mo⁶⁺

(Ba,Sr,Ca)nSinNn:Eu²⁺ (wherein 2ₙ₊₄=3n)

### Ca₃(SiO₄)Cl₂:Eu²⁺

### ZnS:Ag+,Cl˜

(Y,Lu,Gd)₂_{_{—}}ₙCanSi₄N₆₊ₙC₁_{_{—}}ₙ:Ce3+, (wherein OSn̂O.5)
(Lu,Ca,Li,Mg,Y)alpha-SiAlON doped with Eu²⁺ and/or Ce³⁺

### (Ca,Sr,Ba)SiO₂N₂:Eu²⁺,Ce³⁺

For purposes here it is understood that when a phosphor has two or more dopant ions (i.e., those ions following the colon in the above phosphors), this is to mean that the phosphor has at least one (but not necessarily all) of those dopant ions within the material. That is, as understood by those skilled in the art, this notation means that the phosphor can include any or all of those specified ions as dopants in the formulation.

In one embodiment, the LEDs include a violet LED device capable of emitting electromagnetic radiation at a range from about 380 nanometers to about 440 nanometers and the phosphors emit substantially white light, the substantially polarized emission being violet light.

In a specific embodiment, a (1-100) m-plane bulk substrate is provided for the nonpolar violet LED. The substrate has a flat surface, with a root-mean-square (RMS) roughness of about 0.1 nm, a threading dislocation density less than 5×10⁶ cm⁻², and a carrier concentration of about 1×10¹⁷ cm⁻³. Epitaxial layers are deposited on the substrate by metalorganic chemical vapor deposition (MOCVD) at atmospheric pressure. The ratio of the flow rate of the group V precursor (ammonia) to that of the group III precursor (trimethyl gallium, trimethyl indium, trimethyl aluminum) during growth is between about 3000 and about 12000. First, a contact layer of n-type (silicon-doped) GaN is deposited on the substrate, with a thickness of about 5 microns and a doping level of about 2×10¹⁸ cm⁻³. Next, an undoped InGaN/GaN multiple quantum well (MQW) is deposited as the active layer. The MQW superlattice has six periods, comprising alternating layers of 16 nm of InGaN and 18 nm of GaN as the barrier layers. Next, a 10 nm undoped AlGaN electron blocking layer is deposited. Finally, a p-type GaN contact layer is deposited, with a thickness of about 160 nm and a hole concentration of about 7×10¹⁷ cm⁻³. Indium tin oxide (ITO) is e-beam evaporated onto the p-type contact layer as the p-type contact and rapid-thermal-annealed. LED mesas, with a size of about 300×300 μm2, are formed by photolithography and dry etching. Ti/Al/Ni/Au is e-beam evaporated onto the exposed n-GaN layer to form the n-type contact, Ti/Au is e-beam evaporated onto a portion of the ITO layer to form a contact pad, and the wafer is diced into discrete LED dies. Electrical contacts are formed by conventional wire bonding. Other colored LEDs may also be used or combined according to a specific embodiment.

In a specific embodiment, a (1 1-2 2} bulk substrate is provided for a semipolar green LED. The substrate has a flat surface, with a root-mean-square (RMS) roughness of about 0.1 nm, a threading dislocation density less than 5×10⁶ cm⁻², and a carrier concentration of about 1×10¹⁷ cm⁻³. Epitaxial layers are deposited on the substrate by metalorganic chemical vapor deposition (MOCVD) at atmospheric pressure. The ratio of the flow rate of the group V precursor (ammonia) to that of the group III precursor (trimethyl gallium, trimethyl indium, trimethyl aluminum) during growth between about 3000 and about 12000. First, a contact layer of n-type (silicon-doped) GaN is deposited on the substrate, with a thickness of about 1 micron and a doping level of about 2×10¹⁸ cm⁻³. Next, an InGaN/GaN multiple quantum well (MQW) is deposited as the active layer. The MQW superlattice has six periods, comprising alternating layers of 4 nm of InGaN and 20 nm of Si-doped GaN as the barrier layers and ending with an undoped 16 nm GaN barrier layer and a 10 nm undoped Al_{0.1}5Ga_{0.85}N electron blocking layer. Finally, a p-type GaN contact layer is deposited, with a thickness of about 200 nm and a hole concentration of about 7×10¹⁷ cm⁻³. Indium tin oxide (ITO) is e-beam evaporated onto the p-type contact layer as the p-type contact and rapid-thermal-annealed. LED mesas, with a size of about 200×550 μm², are formed by photolithography and dry etching. Ti/Al/Ni/Au is e-beam evaporated onto the exposed n-GaN layer to form the n-type contact, Ti/Au is e-beam evaporated onto a portion of the ITO layer to form a contact pad, and the wafer is diced into discrete LED dies. Electrical contacts are formed by conventional wire bonding.

In another specific embodiment, a (11-22) bulk substrate is provided for a semipolar yellow LED. The substrate has a flat surface, with a root-mean-square (RMS) roughness of about 0.1 nm, a threading dislocation density less than 5×10⁶ cm⁻², and a carrier concentration of about 1×10¹⁷ cm⁻³. Epitaxial layers are deposited on the substrate by metalorganic chemical vapor deposition (MOCVD) at atmospheric pressure. The ratio of the flow rate of the group V precursor (ammonia) to that of the group III precursor (trimethyl gallium, trimethyl indium, trimethyl aluminum) during growth between about 3000 and about 12000. First, a contact layer of n-type (silicon-doped) GaN is deposited on the substrate, with a thickness of about 2 microns and a doping level of about 2×10¹⁸ cm⁻³. Next, a single quantum well (SQW) is deposited as the active layer. The SQW comprises a 3.5 nm InGaN layer and is terminated by an undoped 16 nm GaN barrier layer and a 7 nm undoped Al_{0.15}Ga_{0.85}N electron blocking layer. Finally, a Mg-doped p-type GaN contact layer is deposited, with a thickness of about 200 nm and a hole concentration of about 7×10¹⁷ cm⁻³. Indium tin oxide (ITO) is e-beam evaporated onto the p-type contact layer as the p-type contact and rapid-thermal-annealed. LED mesas, with a size of about 600×450 μm², are formed by photolithography and dry etching. Ti/Al/Ni/Au is e-beam evaporated onto the exposed n-GaN layer to form the n-type contact, Ti/Au is e-beam evaporated onto a portion of the ITO layer to form a contact pad, and the wafer is diced into discrete LED dies. Electrical contacts are formed by conventional wire bonding.

In a specific embodiment, the blend of phosphors capable of emitting substantially blue light, substantially green light, and substantially red light are as stated below. As an example, the blue emitting phosphor is selected from the group consisting of (Ba,Sr,Ca)₅(PO₄)₃(Cl,F,Br,OH):Eu²⁺, Mn²⁺; Sb³⁺, (Ba,Sr,Ca)MgAl₁₀O₁₇:Eu²⁺, Mn²⁺; (Ba,Sr,Ca)BPO₅:Eu²⁺, Mn²⁺; (Sr,Ca)₁₀(PO₄)₆*nB₂O₃:Eu²⁺; 2SrO*0.84P₂O₅*0.16B₂O₃:Eu²⁺; Sr₂Si₃O₈*2SrCl₂:Eu²⁺; (Ba,Sr,Ca)MgₓP₂O₇:Eu²⁺, Mn²⁺; Sr₄Al₁₄O₂₅:Eu²⁺ (SAE); BaAl₈O₁₃:Eu²⁺; and mixtures thereof. As an example, the green phosphor is selected from the group consisting of (Ba,Sr,Ca)MgAl₁₀O₁₇:Eu²⁺, Mn²⁺ (BAMn); (Ba,Sr,Ca)Al₂O₄:Eu²⁺; (Y,Gd,Lu,Sc,La)BO₃:Ce³⁺,Tb³⁺; Ca₈Mg(SiO₄)₄Cl₂:Eu²⁺, Mn²⁺; (Ba,Sr,Ca)₂SiO₄:Eu²⁺; (Ba,Sr,Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)₃(Al,Ga)₅O₁₂:Ce³⁺; (Ca,Sr)₈(Mg,Zn)(SiO₄)₄C₁₂:Eu²⁺, Mn²⁺ (CASI); Na₂Gd₂B₂O₇:Ce³⁺, Tb³⁺; (Ba,Sr)₂(Ca,Mg,Zn)B₂O₆:K,Ce,Tb; and mixtures thereof. As an example, the red phosphor is selected from the group consisting of (Gd,Y,Lu,La)₂O₃:Eu³⁺, Bi³⁺; (Gd,Y,Lu,La)₂O₂S:Eu³⁺, Bi³⁺; (Gd,Y,Lu,La)VO₄:Eu³⁺, Bi³⁺; Y₂(OS)₃:Eu³⁺; Ca₁₋ₓMo_{1-y}Si_{y}O₄: where 0.05≦x≦0.5, 0≦y≦0.1; (Li,Na,K)₅Eu(W,Mo)O₄; (Ca,Sr)S:Eu²⁺; SrY₂S₄:Eu²⁺; CaLa₂S₄:Ce³⁺; (Ca,Sr)S:Eu²⁺; 3.5MgO*0.5MgF₂*GeO₂:Mn⁴⁺ (MFG); (Ba,Sr,Ca)MgₓP₂O₇:Eu²⁺, Mn²⁺; (Y,Lu)₂WO₆:Eu³⁺, Mo⁶⁺; (Ba,Sr,Ca)₃MgₓSi₂O₈:Eu²⁺, Mn²⁺, wherein 1≦x≦2; (RE_{1-y}Ce_{y})Mg₂₋ₓLiₓSi₃₋ₓ.PₓO₁₂, where RE is at least one of Sc, Lu, Gd, Y, and Tb, 0.0001<x<0.1 and 0.001<y<0.1; (Y,Gd,Lu,La)₂₋ₓEuₓW_{1-y}Mo_{y}O₆, where 0.5≦x.≦1.0, 0.01≦y≦1.0; (SrCa)₁₋ₓEuₓSi₅N₈, where 0.01≦x≦0.3; SrZnO₂:Sm⁺³; MₘOₙX, wherein M is selected from the group of Sc, Y, a lanthanide, an alkali earth metal and mixtures thereof; X is a halogen; 1≦m≦3; and 1≦n≦4, and wherein the lanthanide doping level can range from 0.1 to 40% spectral weight; and Eu³⁺ activated phosphate or borate phosphors; and mixtures thereof.

Although phosphors are described above, other “energy-converting luminescent materials” include semiconductors, semiconductor nanoparticles (“quantum dots”), organic luminescent materials, and combinations of them can also be used.

In a specific embodiment, the present packaged device having a flat carrier configuration includes an enclosure, which includes a flat region that is wavelength selective. The enclosure can be made of a suitable material such as an optically transparent plastic, glass, or other material. As also shown, the enclosure has a suitable shape. The shape can be annular, circular, egg-shaped, trapezoidal, or other shape. In the cup carrier configuration, the packaged device is provided within a terraced or cup carrier. The enclosure can be configured to facilitate, even optimize, transmission of electromagnetic radiation reflected from internal regions of the package of the LED device. In a specific embodiment, the wavelength selective material is a filter device that can be applied as a coating through the surface region of the enclosure and the wavelength selective surface is a transparent material such as distributed Bragg Reflector (DBR) stack, a diffraction grating, a particle layer tuned to scatter selective wavelengths, a photonic crystal structure, a nanoparticle layer tuned for plasmon resonance enhancement at certain wavelengths, or a dichroic filter.

In a specific embodiment, the wavelength conversion material is within about three hundred microns of a thermal sink provided by a surface region with thermal conductivity of between 15 Watt/m-Kelvin and 300 Watt/m-Kelvin, and characterized by an average particle-to-particle distance of between 2 times the average particle size of the wavelength conversion material and 5 times the average particle size of the wavelength conversion material.

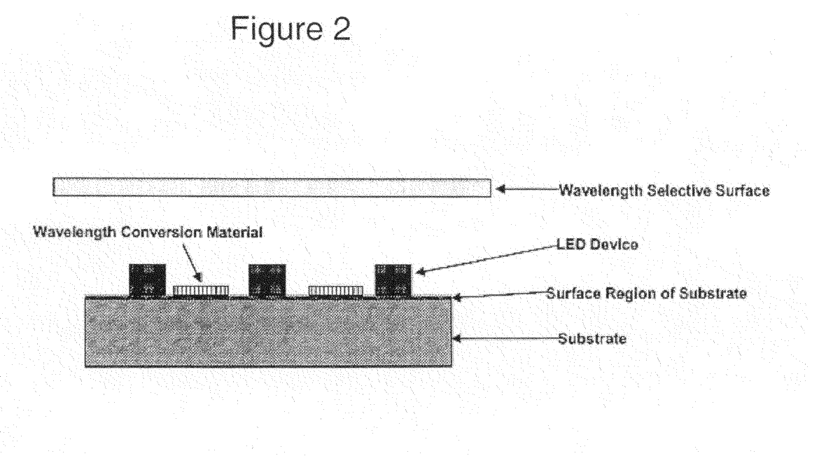

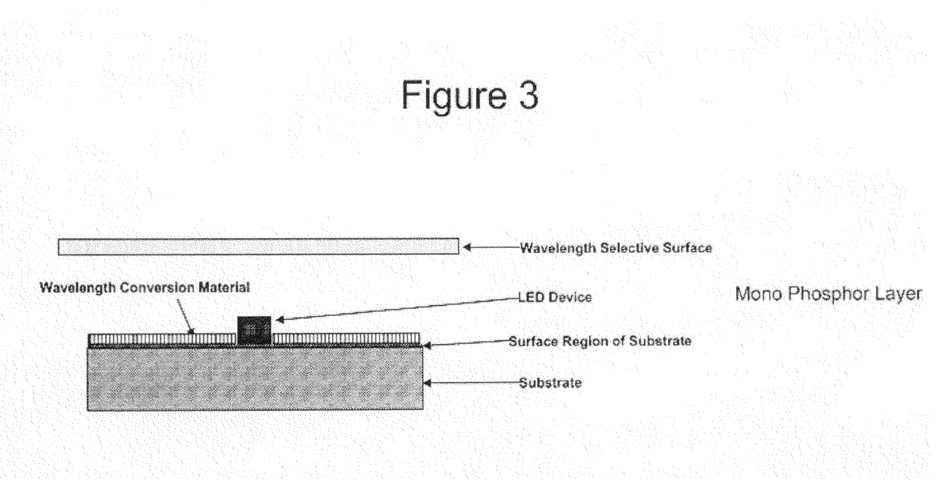

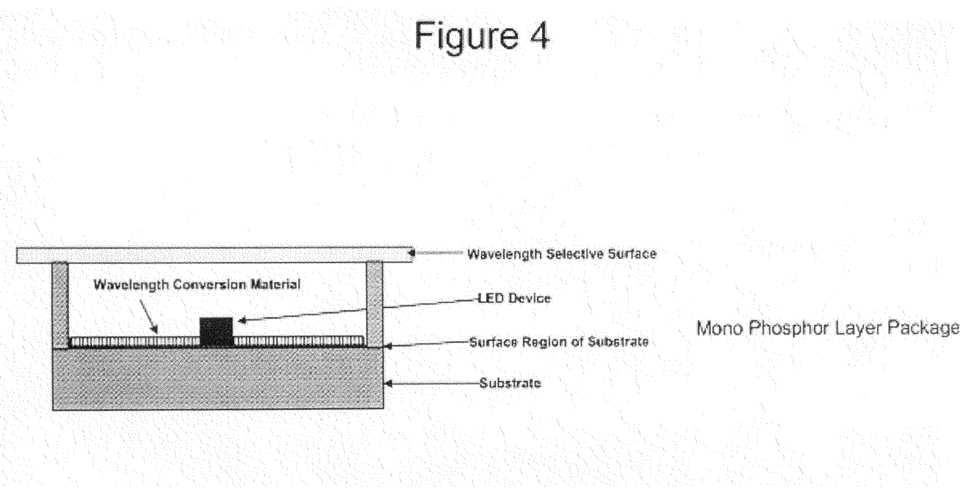

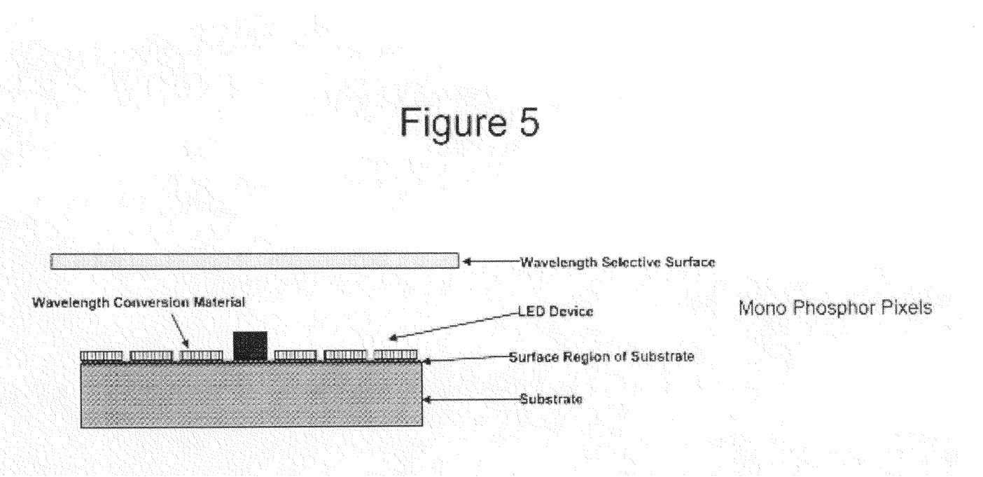

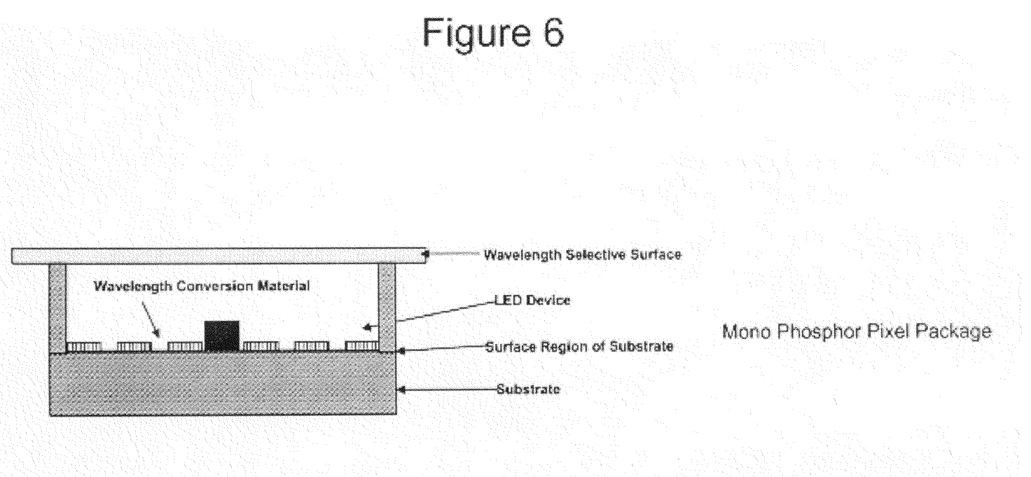

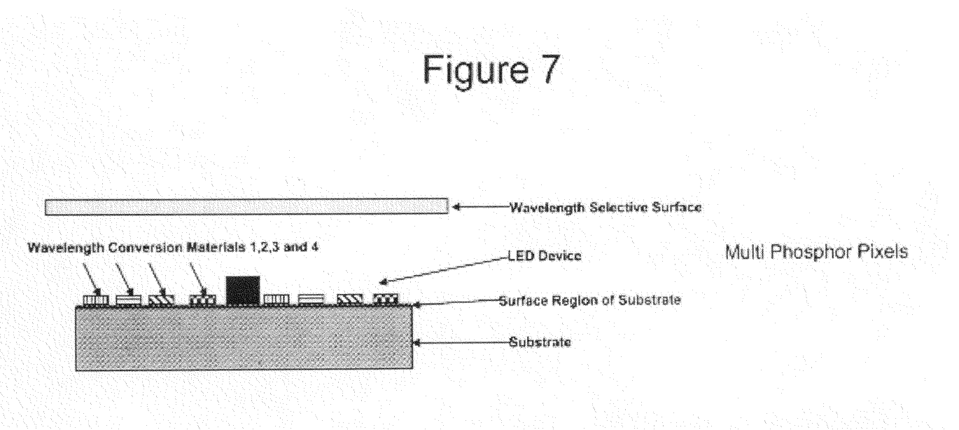

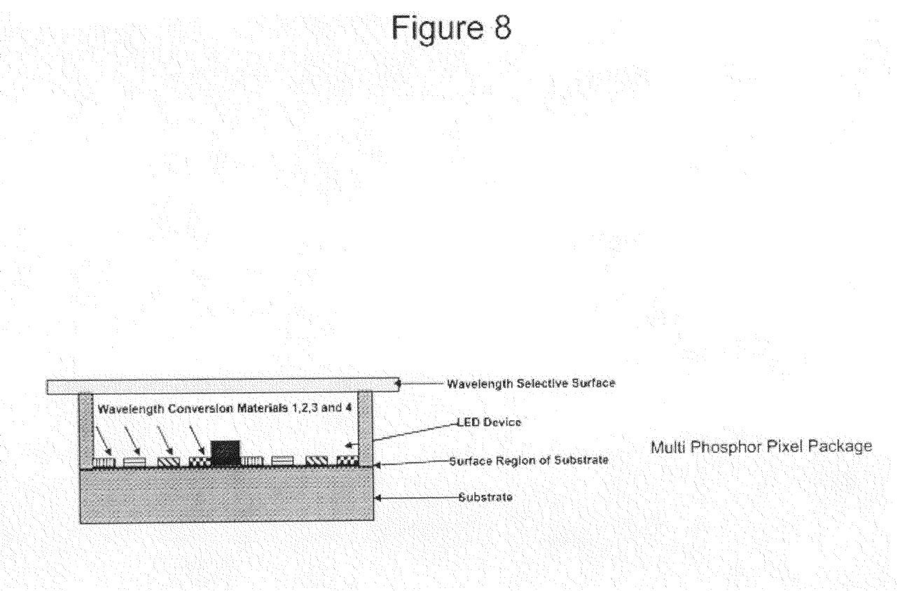

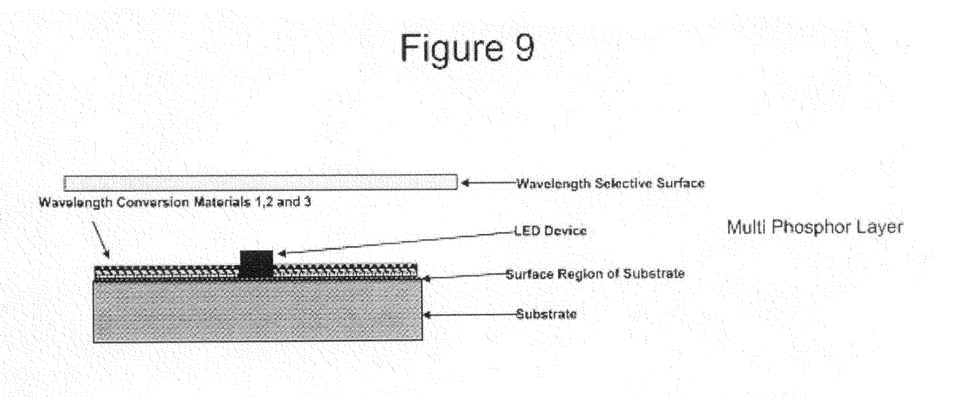

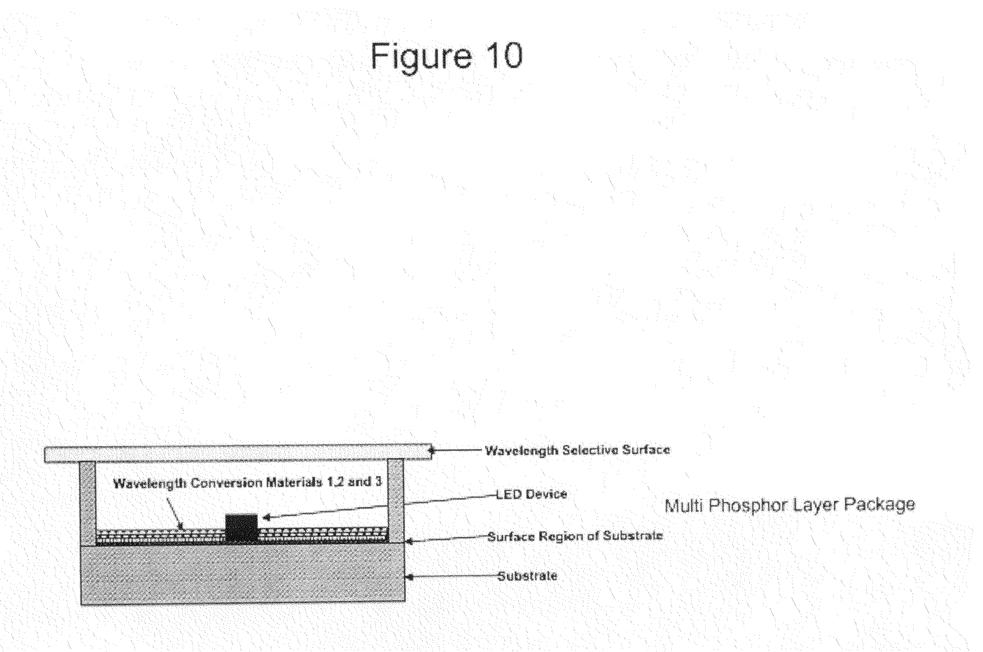

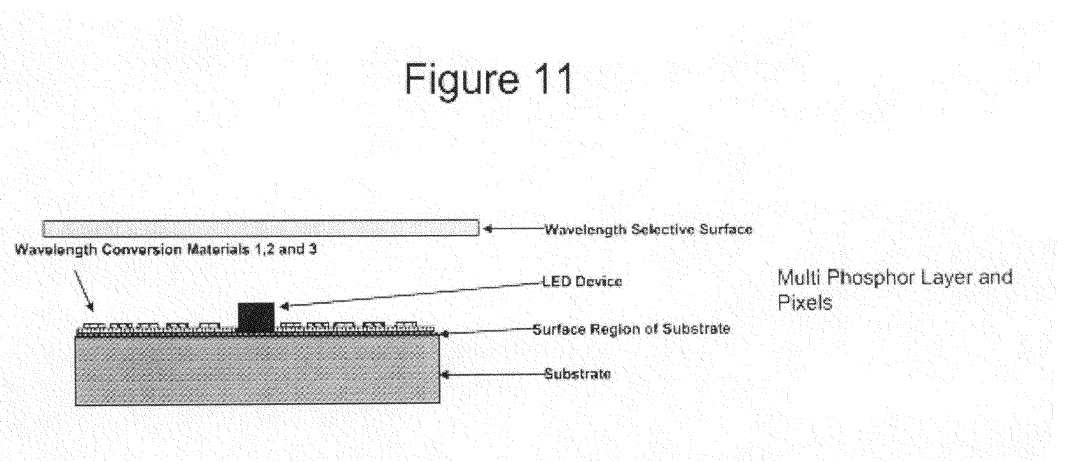

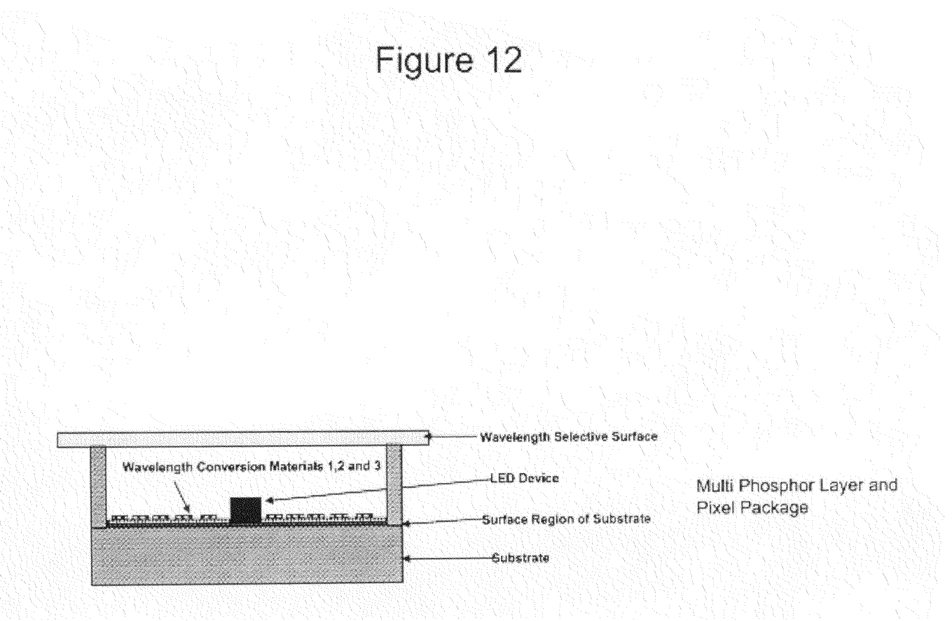

FIGS. 2 through 12 are diagrams of packaged light emitting devices using reflection mode configurations.

In a specific embodiment, the enclosure defines a volume filled containing an inert gas or air. The enclosure defines an optical path from the wavelength selective material to the wavelength conversion material and back through the wavelength conversion material.

In a specific embodiment, the wavelength conversion material is suspended in a suitable medium such as silicone, glass, spin on glass, plastic, polymer, or other material. The medium may initially be in a fluid state and fill and seal an interior region of the enclosure before being cured. The medium is preferably optically transparent or selectively transparent or translucent. Preferably, once cured, the medium is substantially inert. In a preferred embodiment, the medium has a low absorption capability to allow a substantial portion of the electromagnetic radiation generated by the LED device to traverse through the medium and be provided at the second wavelength. In other embodiments, the medium can be doped or treated to selectively filter, disperse, or otherwise influence selected wavelengths of light. As an example, the medium can be treated with metals, metal oxides, dielectrics, or semiconductor materials, and/or combinations of these materials, and the like.

Although the above has been described as a specific package, there can be variations, alternatives, and modifications. For example, the LED can be configured in a variety of packages such as cylindrical, surface mount, power, lamp, flip-chip, star, array, strip, or geometries that rely on lenses (silicone, glass) or sub-mounts (ceramic, silicon, metal, composite).

The packaged device also can include optical and/or electronic devices, e.g. an OLED, a laser, a nanoparticle optical device, etc. In other embodiments, the electronic device can include an integrated circuit, a sensor, a micro-machined electronic mechanical system, or a combination of these.

Preferably, the packaged device can be coupled to a rectifier to convert alternating current power to direct current, which is suitable for the packaged device. The rectifier can be coupled to a suitable base, such as an Edison screw such as E27 or E14, a bipin base such as MR16 or GU5.3, or a bayonet mount such as GU10, etc.

If desired, the device can be configured to achieve spatial uniformity of light emissions. For example, diffusers can be added to the encapsulant. Depending upon the embodiment, the diffusers can include TiO₂, CaF₂, SiO₂, CaCO₃, BaSO₄, and others, which are optically transparent and have a different index than the encapsulant causing the light to reflect, refract, and scatter to make the far field pattern more uniform.

As used herein, GaN substrate is associated with Group III-nitride based materials including GaN, InGaN, AlGaN, or other Group III containing alloys or compositions that are used as starting materials. Such starting materials include polar GaN substrates (i.e., substrate where the largest area surface is nominally an (h k l) plane wherein h=k=0, and l is non-zero), non-polar GaN substrates (i.e., substrate material where the largest area surface is oriented at an angle ranging from about 80-100 degrees from the polar orientation described above towards an (h k l) plane wherein 1=0, and at least one of h and k is non-zero) or semi-polar GaN substrates (i.e., substrate material where the largest area surface is oriented at an angle ranging from about +0.1 to 80 degrees or 110-179.9 degrees from the polar orientation described above towards an (h k l) plane wherein 1=0, and at least one of h and k is non-zero).

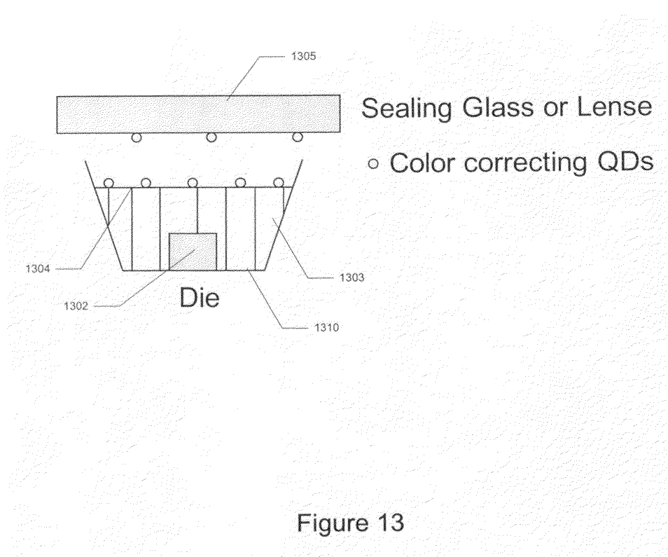

In one embodiment, the invention provides color tuning of LED light using quantum dots. FIG. 13 is a diagram illustrating an LED apparatus having quantum dots. As shown in FIG. 13, an LED diode is provided on a die within a layer of encapsulating material containing phosphor. The phosphor is provided to provide color correction. Since the phosphor color correction is often not by itself sufficient, quantum dots are provided over the phosphor coating layer and the surface sealing member (e.g., sealing glass or lens). In various embodiments, the amount, spacing, and color of the quantum dots are determined by the color output of the LED and the phosphor. For example, the color of light output from the die and phosphor is measured. In conjunction with this color measurement, small amounts of quantum dot (QD) phosphors are applied by jetting or local dispensing to alter the final color of the device by small amounts, impacting the overall brightness and mechanical stability of the part minimally. The QDs can be applied to any available flat surface prior to sealing of the package.

While the optical properties of conventional bulk phosphor powders are determined solely by the phosphor's chemical composition, in quantum dots the optical properties, such as light absorbance are determined by the size of the dot. Changing the size produces changes in color. The small dot size also means that, typically, over 70 percent of the atoms are at surface sites so that chemical changes at these sites allow tuning of the light-emitting properties of the dots, permitting the emission of multiple colors from a single size dot.

As shown in FIG. 13, an LED apparatus includes a substrate. An LED 1302 is positioned on the substrate 1301 and provides light of a specific color, e.g. red, blue, or green. The LED 1302 is a semi-polar or non-polar blue diode manufactured from a bulk substrate of GaN material. A cover 1305 seals the enclosure to protect the LED. The cover member 1305 allows light emitted from the LED 1302 to pass. The cover member 1305 may have color filtering properties, for example, to produce white light from a blue LED device, the cover member 1305 can be provided with a yellow color filter.

The apparatus includes quantum dots to modify the color of light emitted from the LEDs. As shown in FIG. 13, the quantum dots are provided on the surface area 1304 and the cover member 1305. The quantum dots formed on the cover member will have a dot size, a pattern, and a color. These can be determined based on the light color of the LED. For example, if the light from the LED is light blue, loosely patterned small yellow quantum dots can generate white light. If the light color of the LED is blue, densely patterned large yellow quantum dots can generate a desired light color (e.g., mostly commonly warm white light).

It is to be appreciated that quantum dots can be deposited at different parts of the LED apparatus. In one set of embodiments, quantum dots are deposited on the cover member of the LED apparatus. Alternatively, in certain embodiments, the LED apparatus includes encapsulating material and quantum dots can be deposited in the encapsulating material to provide color correction.

For proper and accurate color modification, characteristics of quantum dots are determined based on the color the LED light during the manufacturing process. The following is a simplified process flow for providing quantum dots for an LED apparatus:
1. providing a substrate;
2. defining a surface on the substrate;
3. forming LEDs having a first wavelength on the surface,
4. determining a wavelength conversion factor for converting the first wavelength to a desired wavelength;
5. forming a quantum dot pattern based on the wavelength conversion factor, the quantum dot pattern having a quantum dot size and a quantum dot color;
6. applying the quantum dot pattern to a filter;
7. providing the filter over the LEDs; and
8. sealing the filter to encompass the LEDs.

Semiconductor nano-crystal, or “quantum dot” (QD), materials based on materials such as CdS, CdSe, etc., have been demonstrated as efficient down-conversion media. For example, the quantum dot structure illustrated in FIG. 13 can provide consistent and efficient color conversion. Moreover, these materials have fundamental advantages over conventional phosphors such as the ability to easily tune the emission peak wavelength, and the ability to achieve narrow-band emission (e.g., to about 40 nm or lower). The latter is beneficial for increasing the spectral efficiency of warm white LEDs. Indeed, employing only a red QD down-converter with 40 nm fwhm in combination with conventional blue and green phosphors, a LER of 352 μm/W is achievable for 2700K spectrum with CRI of 90, representing a spectral efficiency of 86%.

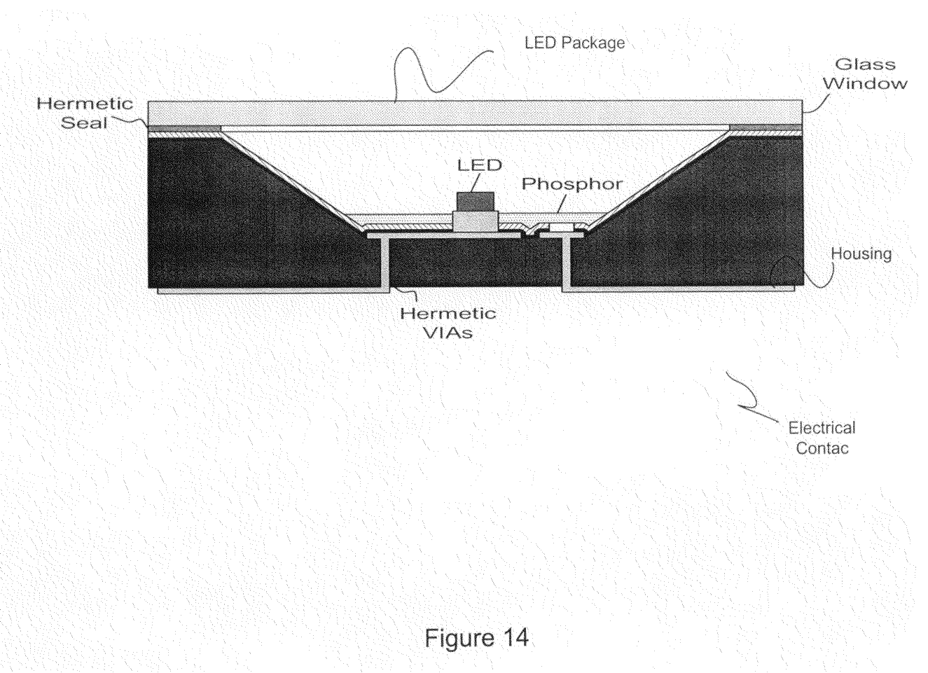

FIG. 14 is a simplified diagram illustrating a hermetically sealed LED package according to an embodiment of the present invention. As shown in FIG. 14, an LED package includes a blue light LED. The LED package also includes luminescent material such as phosphor material. The luminescent material can QDs, and is provided to convert the color of the light emitted by the LED. For example, if the luminescent material emits in yellow color, which converts blue light from the LED to substantially white light that is typically used for general lighting applications.

The LED is positioned within a cavity space in the housing. For example, the housing comprises substantially silicon containing material. In certain embodiments, the cavity is formed by etching of silicon to form 54° sidewalls of the cavity space.

To seal the LED, a substantially transparent cover member is provided such as a glass window shown in FIG. 14. The cover member is hermetically sealed to the housing, thereby enclosing the LED and the luminescent material inside. Depending on the application, the hermetic seal can formed by a number of methods including anodic bonding, fusion bonding, or glass frit. In certain embodiments, both the glass window and the package are first metalized at the sealing regions and then soldered together.

It is to be appreciated that the use of silicon has the advantage in that sealing operation can be done at a wafer level. For example, a 8″ silicon wafer can have a number of housings for LED packages. The housings can be hermetically sealed with a transparent cover member (e.g., glass) that is about the same size as the silicon wafer. After sealing, the packages are singulated.

The configuration as shown in FIG. 14 is suitable for accommodating moisture sensitive luminescent material such as phosphor material based on silicates, nitrido-silicates sulfides, aluminates or thiogallates or nano dots such those material based on ZnSe, ZnS, CdS, Cdse, Zn, Cd, Se, S. The level of hermeticity is <1×10⁻⁶ ATM-cc/sec or less than <1×10⁻⁷ ATM-cc/sec. For example, the luminescent materials are provided in the form of QDs, and as a result the LED package needs to be hermetically sealed to allow the luminescent material to properly function over a long time. Hermetically sealed LED packages with QDs according to the present invention have over 20% better efficiency compared to conventional LED packages.

In various embodiments, devices with an internal cavity volume of 0.01 cc or less are rejected if the equivalent standard leak rate (L) exceeds 5×10-8 atm cc/s air. For example, devices with an internal cavity volume greater than 0.01 cc and equal to or less than 0.4 cc are rejected if the equivalent standard leak rate (L) exceeds 1×10-7 atm cc/s air. Devices with an internal cavity volume greater than 0.4 cc are rejected if the equivalent standard leak rate (L) exceeds 1×10-6 atm cc/s air.

It is to be appreciated QD technologies are used in various types of LED packages. Colloidal QD technology is used for changing the color of the light, from LED devices. QD technology benefits from solubility and stability of polymer materials when used in conjunction with inorganic semiconductors. Emission characteristics of QDs includes narrow band and high color saturation (typically characterized by a single Gaussian spectrum). Optical band gap is controlled by nanocrystal diameter. Thus, it is possible to fine tune absorption and emission wavelength through synthetic and structural changes.

Various types of materials may be used to implemented QD systems. For example, II-VI semiconductor (e.g., CdSe) with a bulk band gap of 1.73 eV (716 nm) can be used to emit across visible spectrum with narrow size distributions and high emission quantum efficiencies. In an example, CdSe-type QDs with 2 nm diameter can be used to emit blue color, while QDs having 8 nm diameters emit in the deep red color. To use QDs for different colors, different types of semiconductor materials with different band gap can be used. For example, the smaller band gap semiconductor CdTe (1.5 eV, 827 nm) can access deeper red colors than CdSe. InP has a direct bulk band gap of 1.27 eV, which can be tuned beyond 2 eV with ZnS blending. InP can provide tunable emission from green to deep red. InP in combination with a small amount of ZnS can be used to tune down into the deep green/aqua blue region of the spectrum. To capture the benefit of QD technology for lighting applications, it is desirable to employ hermetic wafer-level-packaging technology.

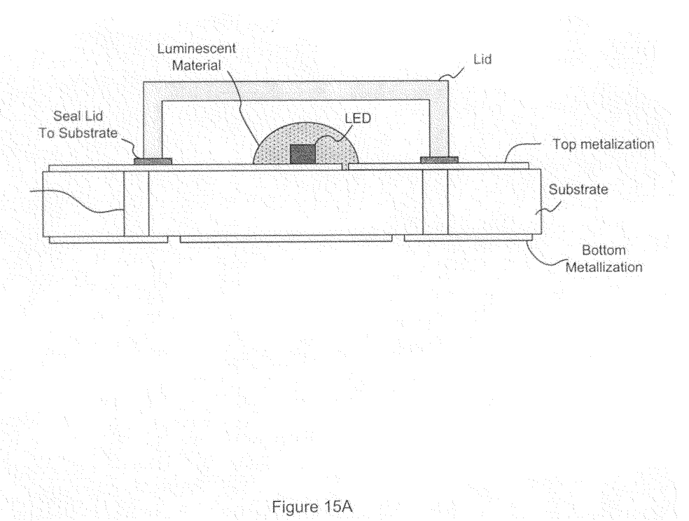

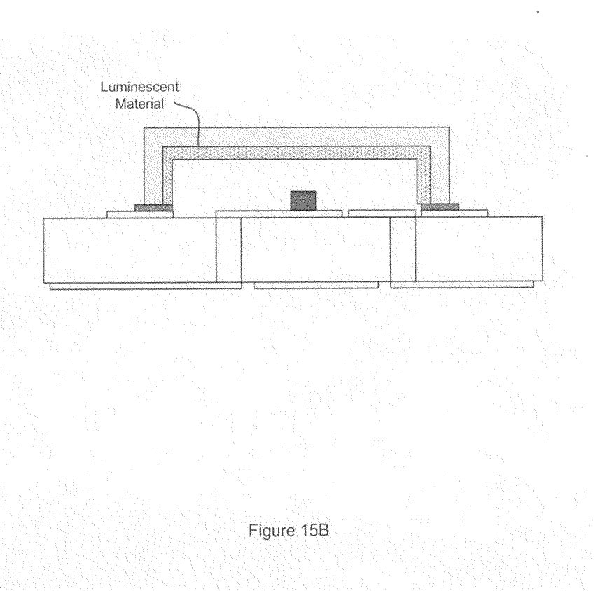

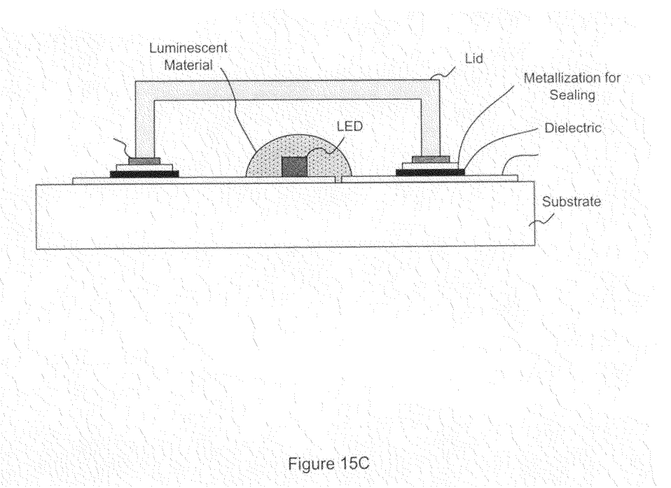

In FIG. 14, the housing has a cavity space. FIGS. 15A-15C are diagrams illustrating LED packages with canopy shaped lid members. In FIG. 15A, an electrical feed-through is provided in a configuration commonly known as a “via”. A via can be formed by a variety of methods including laser drilling, punching, etching, or machining. Through holes at the substrate allow electrical connections to pass through. In various embodiments, vias and the electrical connections are hermetically sealed with a metal material, e.g. copper, copper tungsten, gold, nickel, and/or silver material.

In various embodiments, top and bottom sides of the substrate include metallization layers. The electrical feed-through provides electrical connections from the top and bottom metallization. Depending on the application, the substrate can be a ceramic material including alumina, aluminum nitride, and beryllium oxide.

An LED device is provided on the top side of the substrate and electrically coupled to the electrical feed-through by the top metallization layer. As described above, LED devices are often characterized by a specific color, such as blue, violet, or others. To change the light color from the LED, luminescent material is typically provided. As shown in FIG. 15A, luminescent material encapsulates the LED device. The luminescent material is not restricted to encapsulating the LED, but can be anywhere in the interior of the package including a conformal layer on the top surface of the substrate such as the configuration of FIG. 14. FIG. 15B shows a configuration where the luminescent material is attached to glass lid. For example, the luminescent material comprises phosphor material as shown. The luminescent material can also be comprised of QDs. Combinations of phosphors and QDs may be preferred in some embodiments. The luminescent material is provided to convert the color of the light emitted by the LED. For example, the luminescent material is in yellow color, which converts blue light from the LED to substantially white light that is typically used for general lighting applications.

To protect the LED device and the luminescent material, a lid is provided. As an example, the lid is canopy shaped. The lid is substantially transparent to allow light emitted from the LED to pass through. In various embodiments, the lid is hermetically sealed to the substrate. Depending on the application the sealing between the lid member and the substrate can be accomplished by a variety of means including soldering, anodic bonding, welding, and glass frit.

In FIG. 15B, the lid member is sealing to the top metallization pattern, a process applicable for soldering. For other sealing methods such a glass frit, the glass frit material can seal directly to the substrate without the metallization. In certain embodiments, sealing is accomplished by anodic bonding processes. For example, anodic bonding processes is suitable when the substrate and lid comprises glass or silicon material and the sealing surfaces are flat, and a thin layer of SiO₂ can be used as the sealing material. In FIG. 15B, the QD material can be used as luminescent material on the lid.

In an embodiment, the substrate comprises silicon. The vias can be formed from a dry etching process and then filled with a copper. For example, such structures are often referred to as through silicon via or “TSV”. FIG. 15C illustrates an LED package having planar electrical feed thru. As shown, a dielectric layer is provided between metallization layers of the lid member and the substrate. Among other things, the dielectric layer electrically isolates the top metallization from the sealing metallization and the lid. Such configurations are suitable where the sealing material is soldered.

It is to be appreciated that other configurations are possible as well. In an embodiment, glass frit bonding is used to seal the lid member and the substrate. In such configuration, sealing metallization and the dielectric shown in FIG. 15C are not required, as the glass frit material is electrical insulating and seals directly on the top metallization or top substrate surface.

In certain embodiments, anodic bonding process is used for sealing the lid member and the substrate, the lid can be sealed directly on top of the dielectric material. For example, if the lid is glass or silicon material.

As described above, the lid member is substantially transparent. Among other things, the lid member includes least an optically transmissive region. The lid member includes a cavity space to accommodate the LED and luminescent materials. Additionally, lid member includes one or more surface regions to seal to the substrate. The lid member shown in FIGS. 15A, 15B, and 15C can be formed in various ways. While the above is a full description of the specific embodiments, various modifications, alternative constructions and equivalents may be used.

What is claimed is:

1. An optical device comprising:
a substrate having a surface;
an LED disposed on the surface and emitting at a first wavelength;
a substantially transparent cover encompassing the LED;
a hermetically sealed space between the substrate and the cover, and
a plurality of quantum dots on the cover emitting a second wavelength upon excitation by emission of the LED at the first wavelength.

2. The device of claim 1 wherein the quantum dots comprises CdSe.

3. The device of claim 1 further comprising silicone encapsulating the plurality of quantum dots onto the cover member.

4. The device of claim 1 further comprising epoxy for encapsulating the plurality of quantum dots onto the cover member.

5. The device of claim 1 wherein the substrate comprises metal.

6. The device of claim 1 wherein the second wavelength is white light.

7. The device of claim 1 wherein the surface is substantially planar.

8. The device of claim 1 wherein the plurality of quantum dots comprises a phosphor.

9. The device of claim 1 wherein the substrate and cover define a package.

10. The device of claim 5 wherein the substrate member comprises one of copper or Alloy 42.

11. A method for forming an optical device comprising:
providing a substrate having a surface;
disposing an LED emitting at first wavelength on the surface;
determining a wavelength conversion factor for converting the first wavelength to a desired wavelength;
forming a quantum dot pattern based on the wavelength conversion factor, the quantum dot pattern including a plurality of quantum dots of specific size and color;
applying the quantum dot pattern to a substantially transparent filter;
placing the filter over the LED;
hermetically sealing the filter member

13. An optical device comprising:
a housing having a cavity and a via;
an LED emitting at a first wavelength within the cavity;
a plurality of quantum dots provided within the cavity for converting the first wavelength to a second wavelength;
a cover member coupled to the housing member and hermetically sealing the cavity space; and
at least one electrical contact coupled to the LED device through the via.

14. The device of claim 13 wherein the LED is a blue-emitting LED.

15. The device of claim 13 wherein the LED is a violet-emitting LED.

16. The device of claim 13 wherein the cover member comprises glass.

17. The device of claim 13 wherein the LED comprises a Ga- and N-containing compound.

18. The device of claim 17 wherein the LED devices is characterized by a semi-polar or non-polar crystallographic orientation.
